(19) United States
(12) Patent Application Publication
(10) Pub. No.: US 2004/0196004 A1
(43) Pub. Date: Oct. 7, 2004

(54) Power source circuit for cell and cell pack

(76) Inventor: Hiroshi Sasaki, Miyagi (JP)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/813,171

(22) Filed: Mar. 31, 2004

(30) Foreign Application Priority Data
Apr. 7, 2003 (JP) 2003-102511

(51) Int. Cl. H02J 7/00

(52) U.S. Cl. 320/127

(57) ABSTRACT

A power source circuit for a cell and a cell pack are provided which are capable of operating them, when warnings of operation termination are displayed during use of a portable terminal device, as an emergency operation, in such a case where operation time of the portable terminal device is shortened extremely due to degradation in a discharge characteristic of the cell or due to a voltage drop occurring when the cell is used in a low temperature state. The portable terminal device is operated in a manner that a voltage output from the cell power source circuit is made higher than its operation lower limit voltage when a discharge voltage of the cell becomes lower than its operation lower limit voltage and, as a factor for detecting termination of discharge, the discharge termination is detected according to an amount of voltage drop in the cell per unit time.

### BACKGROUND OF THE INVENTION

1. Field of the Invention

The present invention relates to a power source circuit for a cell and a cell pack and more particularly to the power source circuit for the cell and the cell pack being used in a portable terminal device in particular.

The present application claims priority of Japanese Patent Application No. 2003-102511 filed on Apr. 7, 2003, which is hereby incorporated by reference.

2. Description of the Related Art

Recently, a cell is used mainly as a power source for a portable terminal device, which has following configurations. That is, to electrically connect a cell to a portable terminal device, the cell being packed in a plastic case is fit into the portable terminal device and this structure is commonly called a “cell pack”. The cell pack is so structured as to be able to have circuits adapted to control the cell.

Conventional technology is disclosed in Japanese Patent Application Laid-open No. Hei 11-17584 in which a main power source circuit, when its voltage lowers, judges that the main power source circuit is in an emergency state and adds a voltage from an additional power source by a switching operation, which allows a load operation to be performed in an emergency manner.

However, in the conventional technology, when a cell is used as a power source, there is room for improvements from the viewpoint of safety. The reason is that, when the power source is made up of cells, if the cells each having a different discharge depth such as a main power source and an additional power source are in series connected each other, the cells are discharged in a reverse direction, which, as a result, causes the polarity of the cells to be reversed due to the polarity change phenomenon, for example, in the case of a nickel-cadmium secondary cell in particular, thus causing a possibility of occurrence of heat generation.

### SUMMARY OF THE INVENTION

In view of the above, it is an object of the present invention to provide a power source circuit for a cell and a cell pack which are capable of extending operation time of a portable terminal device by driving the portable terminal device as an emergency operation in such a case where operation time of the portable terminal device is shortened extremely, in the cell pack or the power source circuit for the cell, due to degradation in a discharge characteristic of the cell or due to drop phenomenon in a discharge voltage occurring when an environment surrounding the cell is in a low temperature state.

According to a first aspect of the present invention, there is provided a power source circuit for a cell for controlling transfer of electric energy from the cell to loads, wherein a device employing the power source circuit is operated in a manner that, when a discharge voltage of the cell becomes lower than an operation lower limit voltage of the device to be operated, a voltage output from the power source circuit for the cell is made higher than the operation lower limit voltage of the device by using a voltage increasing unit.

In the foregoing, a preferable mode is one wherein an amount of voltage drop in the cell per unit time is employed as a factor for detecting termination of discharge of the cell.

According to a second aspect of the present invention, there is provided a power source circuit for a cell for controlling transfer of electric energy from the cell to loads, the power source circuit including a cell voltage detecting circuit to detect a voltage of the cell, a discharge controlling circuit, an output voltage detecting circuit, a step-up DC-DC converter, a switching circuit to switch a positive electrode of the cell to either of an output terminal of the power source circuit or an inputting section of the step-up DC-DC converter, and a power storing section mounted in an outputting section of the power source circuit,

wherein the device employing the power source cell is operated in a manner that, when a discharge voltage of the cell becomes lower than an operation lower limit voltage of the device to be operated, a voltage output from the power source circuit for the cell is made higher than the operation lower limit voltage of the device by using the step-up DC-DC converter.

In the foregoing, a preferable mode is one wherein the power storing section includes an electric double layer capacitor.

According to a third aspect of the present invention, there is provided a power source circuit for a cell for controlling transfer of electric energy from the cell to loads, the power source circuit including a cell voltage detecting circuit to detect a voltage of the cell, a control circuit, an output voltage detecting circuit, a step-up DC-DC converter, an inductor, two or more switching circuits, a power storing section mounted in the outputting section, wherein the device employing the power source cell is operated in a manner that, when a discharge voltage of the cell becomes lower than an operation lower limit voltage of the device to be operated, a voltage output from the power source circuit for the cell is made higher than the operation lower limit voltage of the device by using the step-up DC-DC converter.

According to a fourth aspect of the present invention, there is provided a cell pack including a cell, a power source circuit for the cell for controlling transfer of electric energy from the cell to loads, and a case for housing the power source circuit and the cell therein,

wherein a device employing the power source circuit is operated in a manner that, when a discharge voltage of the cell becomes lower than an operation lower limit voltage of the device to be operated, a voltage output from the power source circuit for the cell is made higher than the operation lower limit voltage of the device by using a voltage increasing unit

In the foregoing, a preferable mode is one wherein the cell is a primary cell or a secondary cell.

According to a fifth aspect of the present invention, there is provided a cell pack including a cell, a power source circuit for the cell for controlling transfer of electric energy from the cell to loads, and a case for housing the power source circuit and the cell therein,

wherein the power source circuit includes a cell voltage detecting circuit to detect a voltage of the cell, a discharge controlling circuit, an output voltage detecting circuit, a step-up DC-DC converter, a switching circuit to switch a positive electrode of the cell to either of an output terminal of the power source circuit or an inputting section of the step-up DC-DC converter, and a power storing section mounted in an outputting section of the power source circuit, wherein the device employing the power source cell is operated in a manner that, when a discharge voltage of the cell becomes lower than an operation lower limit voltage of the device to be operated, a voltage output from the power source circuit for the cell is made higher than the operation lower limit voltage of the device by using the step-up DC-DC converter

According to a sixth aspect of the present invention, there is provided a cell pack including a cell, a power source circuit for the cell for controlling transfer of electric energy from the cell to loads, and a case for housing the power source circuit and the cell therein,

wherein the power source circuit includes a cell voltage detecting circuit to detect a voltage of the cell, a control circuit, an output voltage detecting circuit, a step-up DC-DC converter, an inductor, two or more switching circuits, a power storing section mounted in the outputting section, wherein the device employing the power source cell is operated in a manner that, when a discharge voltage of the cell becomes lower than an operation lower limit voltage of the device to be operated, a voltage output from the power source circuit for the cell is made higher than the operation lower limit voltage of the device by using the step-up DC-DC converter.

With the above configurations, when warnings of operation termination are displayed during use of a portable terminal device and when the display of the warnings of operation termination is caused by use of a secondary cell that deteriorates with charging/discharging cycles and/or by use of the portable terminal device in a low temperature environment and in the case where rapid and continuous operations of the portable terminal device are required, the portable terminal device can be operated in an emergency manner. This can be achieved by following reasons.

That is, a portable terminal device, generally, has an operating power source voltage range in which an operation can be ensured. In the voltage range, an upper limit value and a lower limit value are set. The upper limit value is set to be an electromotive force or more occurring when a cell used for the power source is a newly produced one or when the cell is fully charged. The lower limit value is set from a viewpoint of a discharge characteristic of a cell so that the portable terminal device can be operated for a long time while the cell is in a fresh state and in a normal temperature state.

Thus, since a portable terminal device has an operating power source voltage range in which an operation can be ensured, when the number of charging and discharging cycles becomes large, there are some cases in which operating time becomes remarkably short due to a change in a discharging characteristic, which does not occur if the cell is in a fresh state and is used in a normal temperature state, caused by use of a secondary cell having a degraded characteristic and/or by use of the portable terminal device in a low temperature environment.

To prevent such the inconvenience as caused by use of the secondary cell that deteriorates with charging/discharging cycles and/or by use of the portable terminal device in a low temperature environment, as a mean for operations of the portable terminal device in an emergency manner, a portable terminal device is operated in a manner that a voltage output from the cell pack and power source circuit for the cell is made higher than an operation lower limit voltage of the portable terminal device, by using a voltage increasing unit, when a discharge voltage of the cell becomes lower than an operation lower limit voltage of the portable terminal device to be operated and, as a factor for detecting termination of discharge, the discharge termination is detected according to an amount of voltage drop in the cell per unit time and an electric double layer capacitor having a large electrostatic capacity is provided in the output section.

The above operations are explained more in detail. That is, when warnings of termination of the portable terminal device are displayed, if the warning display is though to be due to use of secondary cells deteriorate with charging/discharging cycles or its use in a low temperature environment and if incessantly continuous operations of the portable terminal device are needed, an external control signal to perform operations in an emergency manner is transmitted by an operator. The portable terminal device performs detection of a cell voltage upon receipt of the external signal. When it is detected, as a result of detection, that a cell voltage is higher than a preset threshold voltage being near to an operation lower limit voltage of the portable terminal device, the switching unit connects a cell to an output terminal (positive electrode) which causes an output voltage of the cell pack and the power circuit for the cell to be equal to a cell voltage. At this point, a discharge controlling circuit has judged that the portable terminal device is not in a state of use of a secondary cell that deteriorates with charging/discharging cycles and/or use of a portable terminal device in a low temperature environment. When it is detected that a cell voltage is lower than a preset threshold voltage being near to an operation lower limit voltage of the portable terminal device, the switching unit causes a cell to be connected to a step-up DC-DC converter adapted to raise its voltage to a level enabling the portable terminal device to be operated. At this point, the discharge controlling circuit has judged that the portable terminal device is in a state of use of the secondary cell that deteriorates with charging/discharging cycles and/or use of a portable terminal device in a low temperature environment. The step-up DC-DC converter enables the portable terminal device to be operated in an emergency manner at a voltage output from the cell pack and power source circuit for the cell. To detect the termination of discharge caused by the use of the secondary cell that deteriorates with charging/discharging cycles and/or by the use of a portable terminal device in a low temperature environment, non-linearity of discharge curve of a cell is utilized. A discharge voltage characteristic indicates that an amount of voltage drop in a cell per unit time in a continuous same load varies between an end period of discharge and a period from an initial period of discharge to a middle period of discharge.

Especially, the amount of the cell voltage from the initial period of discharge to the middle period of discharge tends to become large. If an amount of the voltage drop being larger than a threshold voltage which is an amount of a voltage drop per predetermined unit time is detected, it is judged that the cell has been put in a state of termination of discharge. When, as a result of the discharge state judging unit, it is judged that the cell has been in a state of discharge termination, the switching circuit connects, not through the voltage increasing unit, the cell to an output terminal of the cell pack and power source circuit for the cell and the portable terminal device displays warnings of operation termination. The power storing section made up of an electric double capacitor is provided in an output section for the cell pack and power source circuit for the cell. The power storing section, while the step-up DC-DC converter is in operation and when the portable terminal device is in such a heavy-load state as an operation for communication, by discharge of the electric double layer having a large electrostatic capacity, performs a smoothing operation of an output voltage as a first operation and, while the switching circuit is in operation and when the power storing section is in a state of momentary electrical cut-off between the cell and output terminal occurring at time of switching of a contact, performs an operation to back up the power source as a second operation. By performing operations described above, a conventional problem of impairment of safety caused by serial connection of cells each having a conventional different discharge depth is resolved. That is, since the step-up DC-DC converter to increase an output voltage is used, serial connection of cells each having a different discharge depth is not connected.

### BRIEF DESCRIPTION OF THE DRAWINGS

The above and other objects, advantages, and features of the present invention will be more apparent from the following description taken in conjunction with the accompanying drawings in which:

FIG. 1 is a circuit block diagram showing a power source circuit for a cell of a cell pack according to a first embodiment of the present invention;

FIG. 2 is a diagram showing a discharge characteristic of the cell occurring when a portable terminal device is continuously operated according to the first embodiment of the present invention;

FIG. 3 is a diagram showing an output characteristic of the cell pack and power source circuit for the cell according to the first embodiment of the present invention;

FIG. 4 is a circuit block diagram showing a power source circuit for a cell in a cell pack according to a second embodiment of the present invention; and

FIG. 5 is a diagram showing an operation state of a step-up DC-DC converter according to another embodiment of the present invention.

### DETAILED DESCRIPTION OF THE PREFERRED EMBODIMENTS

Best modes of carrying out the present invention will be described in further detail using various embodiments with reference to the accompanying drawings.

### First Embodiment

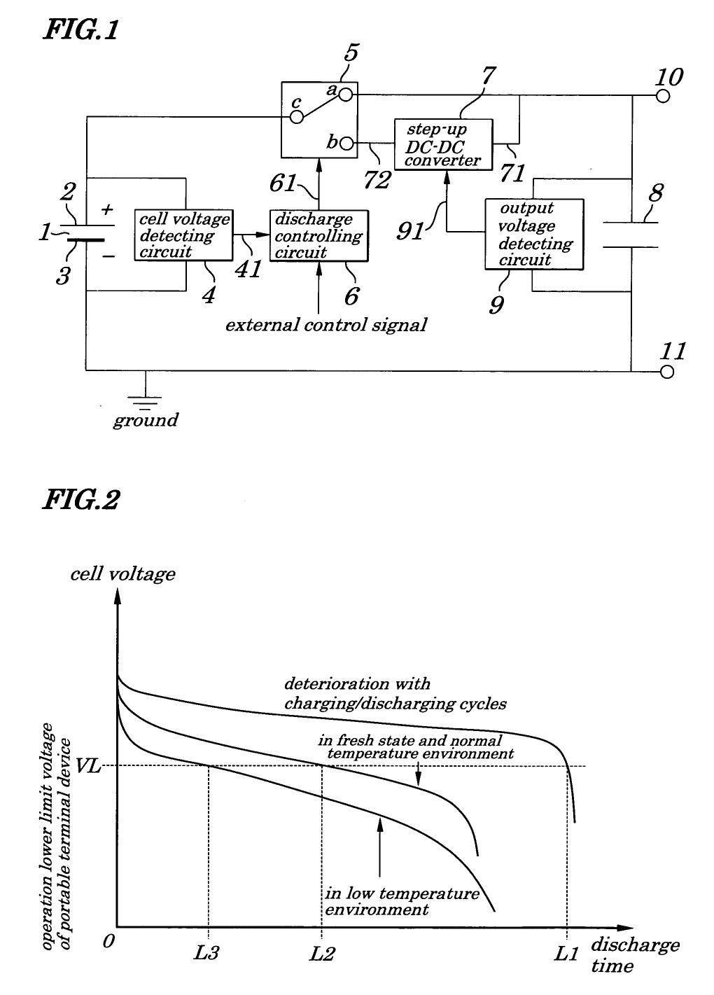

FIG. 1 is a circuit block of a power source circuit for a cell of a cell pack of a first embodiment of the present invention. As shown in FIG. 1, a cell positive electrode 2 of a cell 1 is connected to one terminal of a cell voltage detecting circuit 4 and to a contact “C” of a switching circuit 5. A cell negative electrode 3 is connected to another terminal of the cell voltage detecting circuit 4 and to a ground. A signal line 41 of the cell voltage detecting circuit 4 is connected to a discharge controlling circuit 6 and a signal line 61 of the discharge controlling circuit 6 is connected to the switch circuit 5.

A contact “a” is connected to an output portion 71 of a step-up DC-DC converter 7, an output terminal (positive electrode) 10, one terminal of the power storing section 8, and one terminal of an output voltage detecting circuit 9. A contact “b” of the switching circuit 5 is connected to an input portion 72 of a step-up DC-DC converter 7. Another terminal of the power storing section 8 is connected to an output terminal (negative electrode) 11, the cell negative electrode 3, and another terminal of the output voltage detecting circuit 9. A signal line 91 of the output voltage detecting circuit 9 is connected to the step-up DC-DC converter 7.

In general, a cell can be broadly divided into two groups, one being a primary cell that can be used only once, that is, a single-use cell and another being a secondary cell that can be used repeatedly by charging operations. In the secondary cell, a phenomenon occurs in which, the number of charging and discharging cycles is increased, a discharge voltage curve indicates that the cell voltage becomes lower than that occurring when a newly produced cell is used, due to an increase in internal resistance of the cell. Moreover, in the primary and secondary cells, in such a low temperature environment as a temperature surrounding the cell drops below zero, a phenomenon occurs in which the discharge voltage curve indicates that the cell voltage becomes lower than that occurring at ordinary temperatures.

The cell pack and the power source circuit for the cell of the first embodiment of the present invention shown in FIG. 1 are described in detail below. The cell 1 is made up of a primary cell that can be used only one time or a secondary cell that can be used repeatedly by charging operations. To the cell positive electrode 2 is connected to the positive terminal of the cell 1. To a cell negative electrode 3 is connected to a negative terminal of the cell 1. The cell voltage detecting circuit 4 periodically carries out a measurement of a voltage of the cell 1 and transfers measured results through the signal line 41 to the discharge controlling circuit 6. The switching circuit 5 has three contacts including the contact “a”, contact “b”, and contact “c”. To perform a transfer operation, the contact “c” can be connected to the contact “a” or the contact “b”. When no signal from the discharge controlling circuit 6 is transmitted, the contact “c” and contact “a” are connected to each other.

In the discharge controlling circuit 6, a voltage of the cell 1 transferred from the cell voltage detecting circuit 4 is compared with a predetermined threshold voltage being near an operation lower limit voltage in the portable terminal device and according to a control signal fed from an operator of the portable terminal device, the comparison result is transferred through a signal line 61 to the switching circuit 5.

The step-up DC-DC converter 7 is made up of a switching-type DC-DC converter control circuit and operates to exert circuit control so that a voltage being detected by an output voltage detecting circuit 9 is higher than the operation lower limit voltage of the portable terminal device in a constant manner.

A power storing section 8 is made up of an electric double layer capacitor having an electrostatic capacitance being as large as 10 mF or more. The step-up DC-DC converter 7 operates to smooth an output voltage. The switching circuit 5 is adapted to operate so that no voltage drop occurs in a state of spontaneous electrical cut-off between the cell positive electrode 2 and output terminal (positive electrode terminal) 10. The output voltage detecting circuit 9 makes up a voltage detecting circuit to exert control for feeding back an output voltage while the step-up DC-DC converter 7 is operating. An output terminal (positive electrode) 10 and an output terminal (negative electrode) 11 make up a power supplying terminal for the portable terminal device.

Operations of the power source circuit of the first embodiment of the present invention are described by referring to FIG. 2. FIG. 2 is a diagram showing a discharge characteristic occurring when a portable terminal device is continuously operated. That is, FIG. 2 is a diagram schematically illustrating a discharge characteristic of a cell occurring when the portable terminal device acting as a load is continuously operated in a case where a primary cell is a newly produced one or in a case where a secondary cell is fully charged.

When a cell is in a fresh state and in a normal temperature environment and the load is continuously operated, a discharge curve is provided in which discharge progresses while a cell voltage remains high and a rapid voltage drop occurs at an end period of discharge of the cell. At this point, a voltage at an end period of discharge of the cell is matched to an operation lower limit voltage of the portable terminal device acting as a load and continuous operation time of the portable terminal device becomes L1.

On the other hand, when the cell deteriorates with charging/discharging cycles and the above load is continuously operated in a low temperature environment, a discharge curve is provided in which discharge progresses at a cell voltage being lower than that occurring when the cell is in a fresh state and in a normal environment and its curve is inclined. At this point, since the cell voltage reaches the operation lower limit voltage of the portable terminal device acting as a load at an early stage or middle stage of discharge of the cell, the continuous operation time of the portable terminal device becomes L2 or L3 which is greatly shorter than the L1.

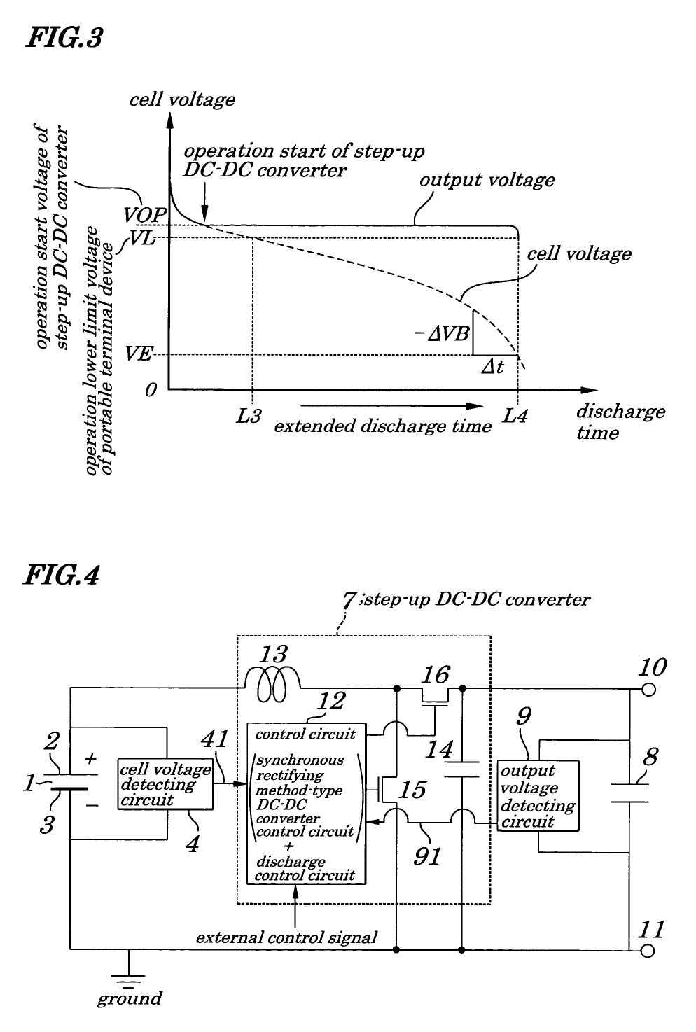

FIG. 3 is a diagram showing an output characteristic of the cell pack and power source circuit for a cell employed in the first embodiment of the present invention. That is, FIG. 3 is a diagram schematically illustrating a discharge characteristic and output characteristic of the cell occurring when the load is continuously operated, by using the cell pack and the power source circuit of the first embodiment, in a low temperature environment shown in FIG. 2. A broken line shows a discharge characteristic of the cell and a solid line shows an output characteristic of the cell pack and the power source circuit for a cell of the first embodiment.

Operations of a circuit block of the cell pack and power source circuit for the cell shown in FIG. 1 are described by referring to FIG. 3. In the cell voltage detecting circuit 4, when a voltage being higher than a preset threshold voltage VOP (same as the operation start voltage of the step-up DC-DC converter) being near to an operation lower limit voltage of the portable terminal device is detected, since no signal from the discharge controlling circuit 6 is transmitted, a contact “c” of the switching circuit 5 is connected to its contact “a” and a voltage from the cell 1 is output between the output terminal (positive electrode) 10 and the output terminal (negative electrode) 11.

When discharge of the cell 1 progresses and when the cell voltage detecting circuit 4 detects a predetermined threshold voltage VOP (same as the operation start voltage of the step-up DC-DC converter) being near to an operation lower limit voltage of the portable terminal device and in a case where rapid and continuous operations by an operator of the portable terminal device are required, if a control signal to perform an operation in an emergency manner is transmitted, the discharge controlling circuit 6 transfers a signal to perform an operation of connecting the contact “c” of the switching circuit 5 to its contact “b”.

Since connection between the contact “c” and contact “b” of the switching circuit 5 allows the step-up DC-DC converter 7 to start operations, an output voltage being higher than the operation lower limit voltage VL of the portable terminal device is produced between the output terminal (positive electrode) 10 and the output terminal (negative electrode) 11 by voltage increasing operations of the step-up DC-DC converter 7, thus driving the portable terminal device. When operations of the step-up DC-DC converter 7 are performed and if the portable terminal device is put in an overloaded state due to its communication operations, operations of smoothing an output voltage are performed by the power storing section 8.

Moreover, when discharge of the cell 1 progresses and a voltage drop being larger than an amount of voltage drop (−ΔVB), being used as a threshold value, per predetermined unit time (Δt) is detected by the cell voltage detecting circuit 4 and if discharge is judged to have been terminated by a method to judge that the cells 1 is in a stopped state when, for example, the cell voltage becomes VE, the discharge controlling circuit 6 operates to transfer no signal and, since the contact “c” of the switching circuit 5 is connected to its contact “a”, a voltage of the cell 1 is output between the output terminal (positive electrode) 10 and the output terminal (negative electrode) 11 and, at the same time, the portable terminal device operates to display warnings of operation termination.

When operations of the switching circuit 5 are performed and the switching circuit 5 is in a state in which cut-off between the cell and output terminal occurs at time of switching contacts, back-up operations for the power source are performed by the power storing section 8. Here, an electric double layer capacitor is used in the power storing section 8. By operations of the cell pack and power source circuit for a cell, operation time required when the load is continuously driven in a low temperature environment can be extended from L3 to L4 as an emergency operation.

### Second Embodiment

A power source circuit for a cell of the second embodiment is described by referring to FIG. 4. FIG. 4 is a circuit block of a power source circuit for a cell housed in a cell pack of the second embodiment. As shown in FIG. 4, a step-up DC-DC converter 7 shown by dotted lines is made up of a control circuit 12 constructed by combining a synchronous rectifying method-based and switching-type DC-DC converter control circuit with a discharge controlling circuit 6, a coil 13, a capacitor 14, a switches 15 and 16 made up of MOSFETs (Metal Oxide Semiconductor Field Effect Transistors).

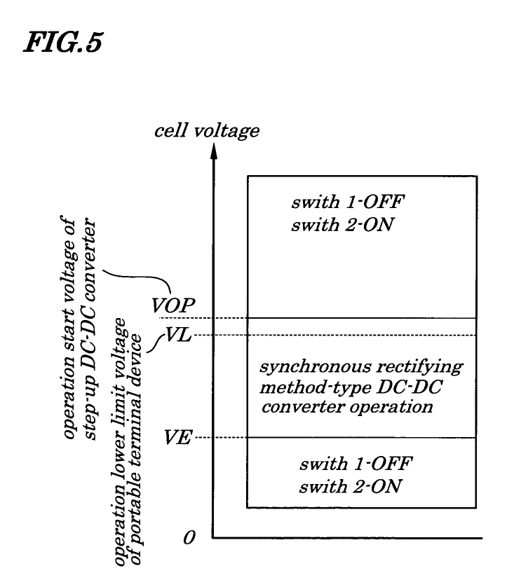

By performing operations of the switching circuit 5 shown in FIG. 1 according to combinations of operations of the switches 15 and 16, same circuit operations as shown in FIG. 1 are performed. FIG. 5 is a diagram showing an operation state of a step-up DC-DC converter of another embodiment of the present invention.

Circuit operations shown in FIG. 4 are described by referring to FIG. 3 and FIG. 5. When the cell voltage detecting circuit 4 detects a voltage being higher than a predetermined threshold voltage VOP (same as an operation start voltage of the step-up DC-DC converter) being near to an operation lower limit voltage of the portable terminal device, the switch 15 is turned OFF and the switch 16 is turned ON. Due to combination of the switching state, a voltage of the cell 1 is output between an output terminal (positive electrode) 10 and an output terminal (negative electrode) 11.

When discharge of the cell 1 progresses and when the cell voltage detecting circuit 4 detects a predetermined threshold voltage VOP (same as the operation start voltage of the step-up DC-DC converter) being near to an operation lower limit voltage of a portable terminal device and in a case where rapid and continuous operations by an operator of the portable terminal device are required and if a control signal to perform an operation in an emergency manner is transmitted, since the switches 15 and 16 start to drive the switching type DC-DC converter control circuit circuit based on a synchronous rectifying method-type by the control circuit 12 constructed by combining a synchronous rectifying method DC-DC converter control circuit and the discharge control circuit 6 shown in FIG. 1, an output voltage being higher than an operation lower limit voltage VL of the portable terminal device is produced by voltage increasing operations between the output terminal (positive electrode) 10 and an output terminal (negative electrode) 11, thus driving the portable terminal device.

When operations of the step-up DC-DC converter 7 are performed and if the portable terminal device is in an overloaded state due to communication operations, operations of smoothing an output voltage are performed by the power storing section 8. Moreover, when discharge of the cell 1 progresses and a voltage drop being larger than an amount of voltage drop (−ΔVB) per predetermined unit time (Δt) being used as a threshold value is detected by the cell voltage detecting circuit 4 and if discharge is judged to have been terminated by a method to judge that discharge is in a stopped state when, for example, the cell voltage becomes VE, the switch 15 is turned OFF and the switch 16 is turned ON. By combination of the above switching state, a voltage of the cell 1 is output between the output terminal (positive electrode) 10 and the output terminal (negative electrode) 11 and, at the same time, the portable terminal device operates to display warnings of operation termination.

When operations of the switching circuit 5 are performed and in a state in which electrical cut-off between the cell and output terminal occurs at time of switching contacts, back-up operations for the power source are performed by the power storing section 8. Due to operations of the cell pack and power source circuit for a cell, operation time required when the load is to be continuously driven in a low temperature environment can be extended from L3 to L4 as an emergency operation.

It is apparent that the present invention is not limited to the above embodiments but may be changed and modified without departing from the scope and spirit of the invention.

What is claimed is:

1. A power source circuit for a cell for controlling transfer of electric energy from said cell to loads, wherein a device employing said power source circuit is operated in a manner that, when a discharge voltage of said cell becomes lower than an operation lower limit voltage of said device to be operated, a voltage output from said power source circuit for said cell is made higher than said operation lower limit voltage of said device by using a voltage increasing unit.

2. The power source circuit for a cell according to claim 1, wherein an amount of voltage drop in said cell per unit time is employed as a factor for detecting termination of discharge of said cell.

3. A power source circuit for a cell for controlling transfer of electric energy from said cell to loads, said power source circuit comprising a cell voltage detecting circuit to detect a voltage of said cell, a discharge controlling circuit, an output voltage detecting circuit, a step-up DC-DC converter, a switching circuit to switch a positive electrode of said cell to either of an output terminal of said power source circuit or an inputting section of said step-up DC-DC converter, and a power storing section mounted in an outputting section of said power source circuit,
wherein said device employing said power source cell is operated in a manner that, when a discharge voltage of said cell becomes lower than an operation lower limit voltage of said device to be operated, a voltage output from said power source circuit for said cell is made higher than said operation lower limit voltage of said device by using said step-up DC-DC converter.

4. The power source circuit for a cell according to claim 3, wherein an amount of voltage drop in said cell per unit time is employed as a factor for detecting termination of discharge of said cell.

5. The power source circuit for a cell according to claim 3, wherein said power storing section comprises an electric double layer capacitor.

6. A power source circuit for a cell for controlling transfer of electric energy from said cell to loads, said power source circuit comprising a cell voltage detecting circuit to detect a voltage of said cell, a control circuit, an output voltage detecting circuit, a step-up DC-DC converter, an inductor, two or more switching circuits, a power storing section mounted in said outputting section, wherein said device employing said power source cell is operated in a manner that, when a discharge voltage of said cell becomes lower than an operation lower limit voltage of said device to be operated, a voltage output from said power source circuit for said cell is made higher than said operation lower limit voltage of said device by using said step-up DC-DC converter.

7. The power source circuit for a cell according to claim 6, wherein an amount of voltage drop in said cell per unit time is employed as a factor for detecting termination of discharge of said cell.

8. The power source circuit for a cell according to claim 6, wherein said power storing section comprises an electric double layer capacitor.

9. A cell pack comprising a cell, a power source circuit for said cell for controlling transfer of electric energy from said cell to loads, and a case for housing the power source circuit and the cell therein,
wherein a device employing said power source circuit is operated in a manner that, when a discharge voltage of said cell becomes lower than an operation lower limit voltage of said device to be operated, a voltage output from said power source circuit for said cell is made higher than said operation lower limit voltage of said device by using a voltage increasing unit.

10. The cell pack according to claim 9, wherein said cell is a primary cell or a secondary cell.

11. A cell pack comprising a cell, a power source circuit for said cell for controlling transfer of electric energy from said cell to loads, and a case for housing the power source circuit and the cell therein,
wherein said power source circuit comprises a cell voltage detecting circuit to detect a voltage of said cell, a discharge controlling circuit, an output voltage detecting circuit, a step-up DC-DC converter, a switching circuit to switch a positive electrode of said cell to either of an output terminal of said power source circuit or an inputting section of said step-up DC-DC converter, and a power storing section mounted in an outputting section of said power source circuit, wherein said device employing said power source cell is operated in a manner that, when a discharge voltage of said cell becomes lower than an operation lower limit voltage of said device to be operated, a voltage output from said power source circuit for said cell is made higher than said operation lower limit voltage of said device by using said step-up DC-DC converter.

12. The cell pack according to claim 11, wherein said cell is a primary cell or a secondary cell.

13. A cell pack comprising a cell, a power source circuit for said cell for controlling transfer of electric energy from said cell to loads, and a case for housing the power source circuit and the cell therein,
wherein said power source circuit comprises a cell voltage detecting circuit to detect a voltage of said cell, a control circuit, an output voltage detecting circuit, a step-up DC-DC converter, an inductor, two or more switching circuits, a power storing section mounted in said outputting section, wherein said device employing said power source cell is operated in a manner that, when a discharge voltage of said cell becomes lower than an operation lower limit voltage of said device to be operated, a voltage output from said power source circuit for said cell is made higher than said operation lower limit voltage of said device by using said step-up DC-DC converter.

14. The cell pack according to claim 13, wherein said cell is a primary cell or a secondary cell.
